(19) United States
(12) Patent Application Publication
(10) Pub. No.: US 2012/0018047 A1
(43) Pub. Date: Jan. 26, 2012

(54) METHOD OF FORMING WOODEN PIECE

(75) Inventor: Tatsuya SUZUKI, Tokyo (JP)

(73) Assignee: OLYMPUS CORPORATION, Tokyo (JP)

(21) Appl. No.: 13/250,221

(22) Filed: Sep. 30, 2011

Related U.S. Application Data
(63) Continuation of application No. PCT/JP2010/056023, filed on Apr. 1, 2010.

(30) Foreign Application Priority Data
Apr. 2, 2009 (JP) 2009-090406

(51) Int. Cl. B27M 1/02

(52) U.S. Cl. 144/380

(57) ABSTRACT

A method of forming a wooden piece forms the wooden piece into a predetermined three-dimensional shape by compressing the wooden piece. The method includes attaching an elastic reinforcing member to an area of an inner surface of a wooden piece that is cut out to be substantially bowl-shaped, the area including a point where a change in curvature before and after compression is largest and separation of grain is largest; softening the wooden piece to which the reinforcing member is attached in a water-vapor atmosphere at a higher temperature and pressure than those in an atmospheric air; and compressing the softened wooden piece in the water-vapor atmosphere so as to deform the wooden piece into a predetermined three-dimensional shape.

### CROSS-REFERENCE TO RELATED APPLICATIONS

This application is a continuation of PCT international application Ser. No. PCT/JP2010/056023 filed on Apr. 1, 2010 which designates the United States, incorporated herein by reference, and which claims the benefit of priority from Japanese Patent Application No. 2009-090406, filed on Apr. 2, 2009, incorporated herein by reference.

### BACKGROUND OF THE INVENTION

1. Field of the Invention

The present invention is related to a method of forming a wooden piece so that the wooden piece is formed into a predetermined three-dimensional shape by compressing the wooden piece.

2. Description of the Related Art

In recent years, wooden materials that are natural materials attract attention. With a wide variety of grain patterns, wood products made of wood exhibit individual features depending on positions of the raw wood from which the particular wood products are cut out. Such individual features of each wood product give it a unique quality. In addition, surface flaws and discolorations caused by a long-term use create unique textures which tend to evoke warm and familiar feeling in the user. Thus, the wooden material attracts attention as a material for products of uniqueness and taste which cannot be found in products made of synthetic resin or light metals. Techniques for molding wooden materials are also developing dramatically.

According to one conventionally known technique for molding wooden materials: a wooden board is softened with water absorption and compressed; the compressed wooden board is cut along a direction substantially parallel with a direction in which the compressive force is applied, whereby a primary fixed product with a sheet-like shape is obtained; and the primary fixed product is deformed into a desired three-dimensional shape under heat and moisture (for example, see Japanese Patent No. 3078452). Further, according to another conventional technique, a softened wooden sheet is compressed and temporarily secured in a prepared mold and left in the mold until the wooden sheet recovers. Thus a wood product with a desired shape can be obtained (see, for example, Japanese Laid-open Patent Publication No. 11-77619).

### SUMMARY OF THE INVENTION

A method of forming a wooden piece according to an aspect of the present invention forms the wooden piece into a predetermined three-dimensional shape by compressing the wooden piece, and includes attaching an elastic reinforcing member to an area of an inner surface of a wooden piece that is cut out to be substantially bowl-shaped, the area including a point where a change in curvature before and after compression is largest and separation of grain is largest; softening the wooden piece to which the reinforcing member is attached in a water-vapor atmosphere at a higher temperature and pressure than those in an atmospheric air; and compressing the softened wooden piece in the water-vapor atmosphere so as to deform the wooden piece into a predetermined three-dimensional shape.

The above and other features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a flowchart that illustrates the outline of a process in a method of forming a wooden piece according to an embodiment of the present invention;

FIG. 2 is a diagram that illustrates the outline of a cutting-out process in the method of forming a wooden piece according to the embodiment of the present invention;

FIG. 3 is a diagram that illustrates the outline of a process for attaching a reinforcing member in the method of forming a wooden piece according to the embodiment of the present invention;

FIG. 4 is a diagram that illustrates the outline of a compression process in the method of forming a wooden piece according to the embodiment of the present invention;

FIG. 5 is a diagram that illustrates a state where compression has started in the compression process;

FIG. 6 is a diagram that illustrates a state in which the deformation of a wooden piece is almost complete in the compression process;

FIG. 7 is a perspective view that illustrates the configuration of a wooden piece that is obtained after compression forming;

FIG. 8 is a perspective view that illustrates the exterior configuration of a digital camera as an example of the application of a wooden piece formed by using the method of forming a wooden piece according to the embodiment of the present invention; and

FIG. 9 is a diagram that illustrates the outline of a process for attaching a reinforcing member in a method of forming a wooden piece according to another embodiment of the present invention.

### DETAILED DESCRIPTION OF THE PREFERRED EMBODIMENTS

An explanation is given of preferred embodiments (hereinafter, referred to as “embodiments”) of the present invention with reference to the accompanying drawings. The drawings that are referred to in the following descriptions are schematically illustrated. When the same object is illustrated in a different drawing, its dimension, scale, or the like may be different.

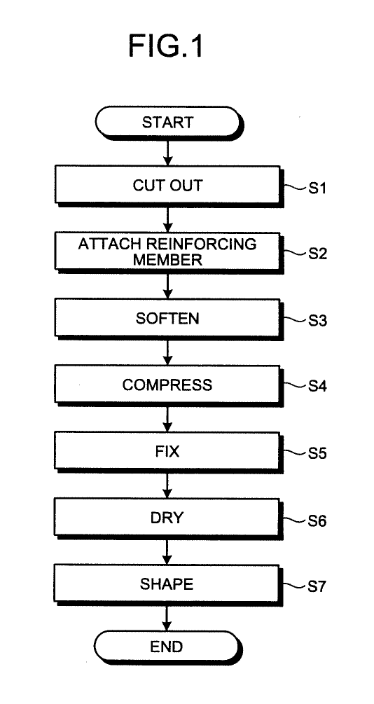

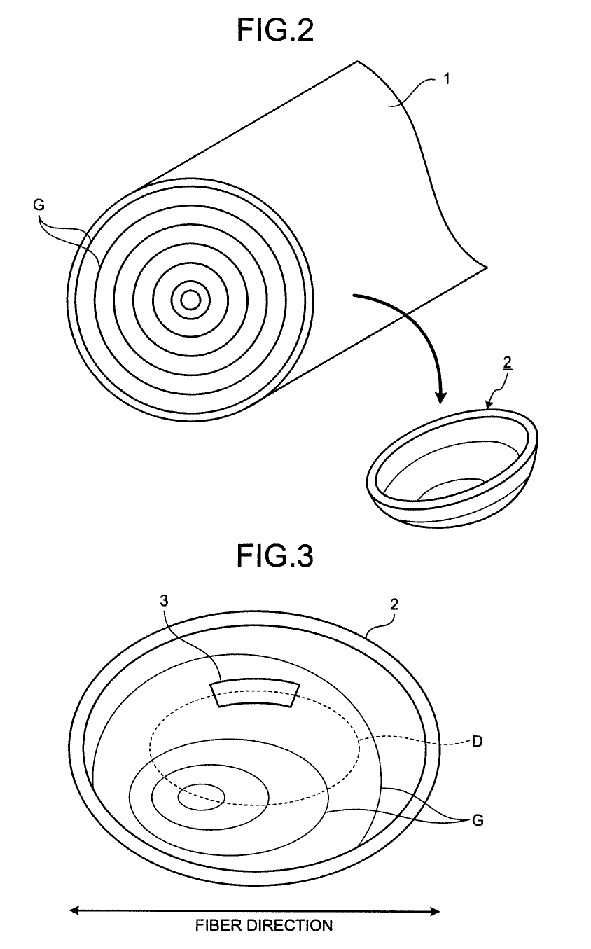

FIG. 1 is a flowchart that illustrates the outline of a method of forming a wooden piece according to an embodiment of the present invention. In the method of forming a wooden piece according to the first embodiment, a substantially bowl-shaped wooden piece is first cut out from raw wood (Step S1). FIG. 2 is a diagram that illustrates the outline of the cutting-out process and that schematically illustrates a state where a substantially bowl-shaped wooden piece 2 is cut out from raw wood 1. At Step S1, a wooden piece is cut out such that the volume of the wooden piece includes an additional volume that corresponds to the volume that is lost due to the process described later. The raw wood 1 may be appropriately selected from hinoki cypress, hiba cedar, paulownia, Japanese cedar, pine, cherry, zelkova, ebony wood, red sandalwood, bamboo, teak, mahogany, rosewood, and the like depending on the intended use of the formed wooden piece. Part of the raw wood 1 to be cut out may be determined depending on a condition such as the strength or appearance required for the wooden piece.

Next, a reinforcing member is attached to the wooden piece 2 (Step S2). FIG. 3 is a diagram that illustrates the outline of a process for attaching a reinforcing member and is a plan view of the wooden piece 2 in FIG. 2 when viewed from above. In FIG. 3, a closed curve D in the form of an ellipse indicated by a broken line is the boundary area between the bottom and the rising area that are obtained after the wooden piece 2 is compressed. Specifically, with respect to the wooden piece 2, a change in curvature is largest in an area adjacent to the closed curve D. In the case illustrated in FIG. 3, the separation of the grain G is largest near the middle of the upper portion of the closed curve D; therefore, there is a high possibility that this area needs reinforcement after compression rather than other areas. Thus, in the case illustrated in FIG. 3, a reinforcing member 3 is attached to this area.

The reinforcing member 3 has a similar component to a wooden piece and is composed of an elastic material. Specifically, the reinforcing member 3 is composed of a cloth or nonwoven cloth made of cotton, hemp, silk, flax, or the like that is a natural fiber that includes a wood fiber component such as cellulose or is composed of rayon, or the like that is a regenerated cellulose fiber. The reinforcing member 3 may be attached to the wooden piece 2 by using an adhesive agent; however, because the reinforcing member 3 and the wooden piece 2 are bonded with each other by a resin component of the wooden piece 2 after compression, it is only necessary to use an extremely small amount of adhesive agent for the attachment that is just enough to determine the position of the reinforcing member 3 with respect to the wooden piece 2. It is preferable to attach the reinforcing member 3 such that at least the fiber direction of the wooden piece 2 intersects with the fiber of the reinforcing member 3. The shape of the reinforcing member 3 can be appropriately changed depending on the size of the area to which the reinforcing member 3 is to be attached.

Next, the wooden piece 2 is left for a predetermined time in a water-vapor atmosphere at a higher temperature and pressure than those in the atmospheric air so as to absorb an excessive amount of water so that the wooden piece 2 becomes softened (Step S3). The water vapor has a temperature of about 100 to 230° C. and a pressure of about 0.1 to 3.0 MPa (megapascal). Such a water-vapor atmosphere can be produced by using, for example, a pressure vessel. If a pressure vessel is used, the wooden piece 2 is left in the pressure vessel so as to be softened. Instead of leaving the wooden piece 2 in a water-vapor atmosphere so as to be softened, the wooden piece 2 may be softened by heating using a high-frequency electromagnetic wave, such as a microwave, after water is applied to the surface of the wooden piece 2, or the wooden piece 2 may be softened by boiling.

Afterward, the wooden piece 2, which has been adequately softened at Step S3, is compressed in a similar water-vapor atmosphere to that at Step S3 described above (Step S4). If the wooden piece 2 is softened in the pressure vessel, the wooden piece 2 may be continuously compressed in the pressure vessel.

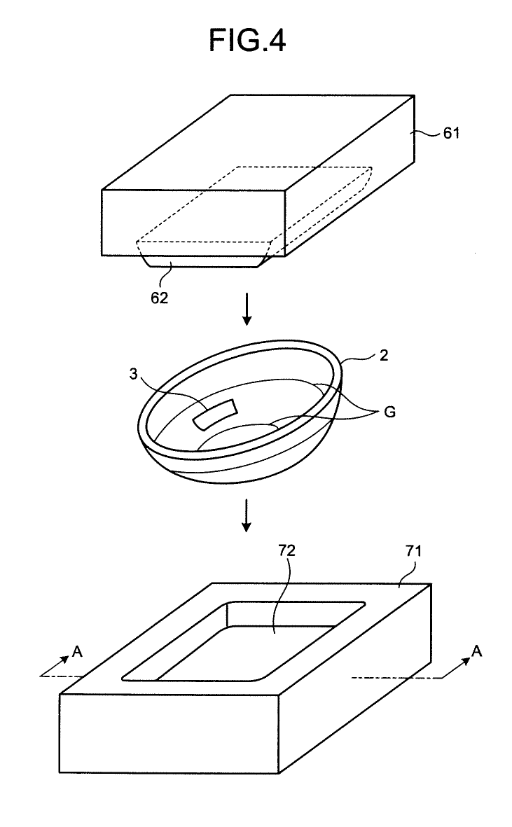

FIG. 4 is a diagram that illustrates the outline of a compression process and also illustrates the configurations of a pair of metal molds to be used in the compression process. A metal mold 61 is a core metal mold that applies a compressive force to the wooden piece 2 from above in FIG. 4 and that includes a protrusion 62 that can be brought into contact with the inner surface of the wooden piece 2. Conversely, a metal mold 71 is a cavity metal mold that applies a compressive force to the wooden piece 2 from below in FIG. 4 and that includes a depression 72 that can be brought into contact with the outer surface of the wooden piece 2.

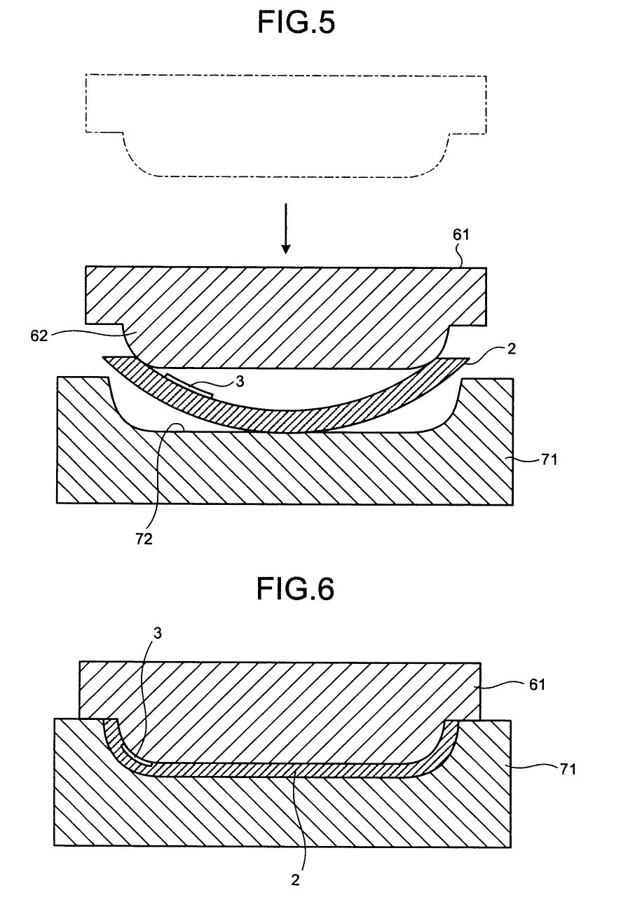

FIG. 5 is a diagram that illustrates a state where the metal mold 61 is in contact with the wooden piece 2 and a compressive force has started to be applied to the wooden piece 2 from the metal molds 61, 71. Furthermore, FIG. 5 is a longitudinal sectional view taken along the line A-A for the wooden piece 2 and the metal molds 61, 71 illustrated in FIG. 4.

If the metal mold 61 is moved downward as illustrated in FIG. 5, the wooden piece 2 is gradually deformed due to the compressive forces from the metal molds 61, 71. As a result, the upper surface of the wooden piece 2 is closely attached to the surface of the protrusion 62, meanwhile the lower surface of the wooden piece 2 is closely attached to the surface of the depression 72. FIG. 6 is a diagram that illustrates a state in which there is such a close attachment and illustrates a state in which the deformation of the wooden piece 2 is almost complete in the compression process. As illustrated in FIG. 6, the wooden piece 2 is deformed into a three-dimensional shape that corresponds to the gap between the metal mold 61 and the metal mold 71. In the compression process, a compressive force is continuously applied to the wooden piece 2, which is in the state illustrated in FIG. 6, for a predetermined time (one to several tens of minutes, and more preferably five to ten minutes).

By this compression process, the surface of the reinforcing member 3 becomes flat with respect to the surface of the wooden piece 2, and the reinforcing member 3 sinks into the wooden piece 2 (see FIG. 6). Because a major component of a fiber of the reinforcing member 3 is the same as a component contained in the wooden piece, the reinforcing member 3 has similar physical properties, such as the degree of shrinkage expressed using a linear expansion coefficient, to the wooden piece; therefore, the reinforcing member 3 has a high affinity to the wooden piece. Hence, the reinforcing member 3 does not damage, for example, cut the fibers of the wooden piece 2, and the reinforcing member 3 is fixed to the surface of the wooden piece 2 in a state where it fits into the wooden piece 2.

After the compression process is complete, water vapor at a higher temperature than the above-described waver vapor is applied to the surroundings of the metal molds 61, 71 while the clamped state of the metal molds 61, 71 is maintained so that the shape of the wooden piece 2 is fixed (Step S5). If the fixing process is performed in the pressure vessel, water vapor at a higher temperature than that in the compression process may be brought into the pressure vessel.

Next, the metal molds 61, 71 and the wooden piece 2 are exposed to the atmospheric air so that the wooden piece 2 is dried (Step S6). At that time, the clamped state of the metal molds 61, 71 may be released to separate the metal mold 61 or 71 from the wooden piece 2 so as to facilitate drying of the wooden piece 2. It is preferable that, after the drying is complete, the thickness of the wooden piece 2 is about 30 to 50% of the thickness of the wooden piece 2 that is obtained before the compression. This corresponds to the compression rate of the wooden piece 2 being about 0.50 to 0.70. Hereinafter, the wooden piece 2 for which the drying process has been completed is referred to as a “wooden piece 4”.

After Step S6, a process for cutting edge surfaces, or the like is performed on the wooden piece 4 so that the wooden piece 4 is formed into a predetermined shape (Step S7).

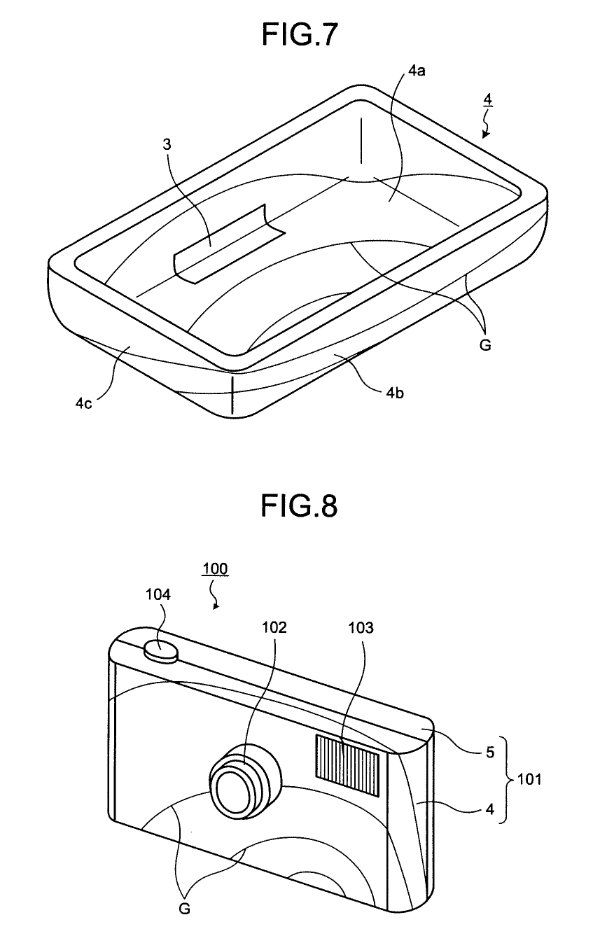

FIG. 7 is a perspective view that illustrates the configuration of a wooden piece formed by the above-described method of forming a wooden piece. The wooden piece 4 illustrated in the same figure includes a main plate portion 4a that has a flat-plate shape with a substantially rectangular surface; two side plate portions 4b that each extend as if rising up with respect to the main plate portion 4a from two sides that are substantially parallel to the longitudinal direction of the surface of the main plate portion 4a; and two side plate portions 4c that each extend as if rising up with respect to the main plate portion 4a from two sides that are substantially parallel to the transverse direction of the surface of the main plate portion 4a. The edge surfaces of the side plate portions 4b, 4c are connected to each other, and these edge surfaces create a complete loop so as to form a closed rectangle. The thickness of the wooden piece 4 is almost uniform.

FIG. 8 is a perspective view that illustrates the configuration of a digital camera whose exterior cover is partially made of the wooden piece 4. A digital camera 100 illustrated in the same figure includes an exterior cover 101, an imaging unit 102, a flash 103, and a shutter button 104. The front surface of the exterior cover 101 is obtained by forming, on the wooden piece 4, an opening through which the imaging unit 102 and the flash 103 are exposed and a cutout through which part of the flash 103 is exposed. Conversely, the rear surface of the digital camera 100 is covered by a wooden piece 5 that is formed by using the wooden piece 2 in the same manner as the wooden piece 4. Because the grain of the wooden piece 5 is different from that of the wooden piece 4, the reinforcing member 3 is attached to a different area. It is preferable that the thickness of the wooden pieces 4 and 5 that form the exterior cover 101 be about 0.8 to 2.0 mm.

In the digital camera 100 that has the above-described configuration, the outer surface of the wooden piece 2 becomes the front surface of the exterior cover 101; therefore, the reinforcing member 3 attached to the inner surface of the wooden piece 2 is hidden on the back surface. Thus, the attachment of the reinforcing member 3 does not spoil the external appearance of the exterior cover 101.

The wooden piece 4 can be used as an exterior cover of an electronic device other than a digital camera.

According to the embodiment of the present invention as described above, an elastic reinforcing member is attached to an area of the inner surface of a wooden piece that is cut out to be substantially bowl-shaped, and the area includes a point where a change in curvature before and after compression is largest and grain separation is largest; thus, it is possible to form a wooden piece with a desired strength irrespective of the state of the grain and to improve the yield ratio of formed pieces.

Furthermore, according to the present embodiment, there is a low possibility that residual stress remains after compression as in the case where, for example, reinforcement is applied to the entire inner surface that is substantially bowl-shaped; therefore, it is possible to maintain the shape stability of a product as well as to apply reinforcement to a weak area. In addition, a small amount of reinforcing member is needed and therefore it is possible to achieve saving of resources and low costs.

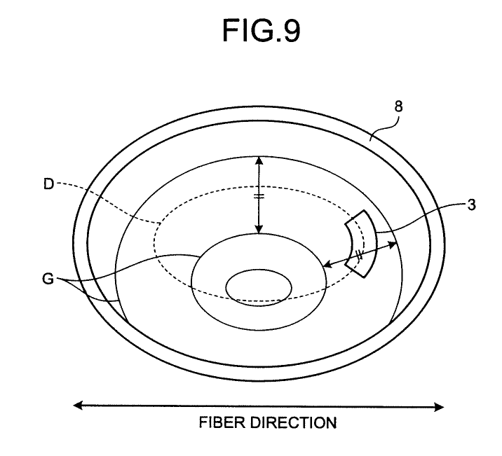

The preferred embodiment of the present invention has been described so far; however, the present invention should not be limited to the above-described embodiment. FIG. 9 is a diagram that illustrates the outline of a process for attaching a reinforcing member in a method of forming a wooden piece according to another embodiment of the present invention. Although a wooden piece 8 illustrated in FIG. 9 has the same shape (the substantially bowl shape) as that of the above-described wooden piece 2, the pattern of the grain G is different. In FIG. 9, the area with the largest separation of the grain G in the elliptical closed curve D is located near the top end and the right end illustrated in the figure. In such a case, according to the above-described embodiment, the reinforcing members 3 are attached to both areas. Conversely, in FIG. 9, the reinforcing member 3 is attached to, out of the two areas that have almost the same separation of the grain G, only the middle portion on the right side that has a larger degree of bentness of fibers of the wooden piece before and after compression. Thus, it is possible to keep the amount of the reinforcing member 3 to be used to a minimum by considering the fiber direction of a wooden piece and a deformed state of a wooden piece before and after compression.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of forming a wooden piece so that the wooden piece is formed into a predetermined three-dimensional shape by compressing the wooden piece, the method comprising:
attaching an elastic reinforcing member to an area of an inner surface of a wooden piece that is cut out to be substantially bowl-shaped, the area including a point where a change in curvature before and after compression is largest and separation of grain is largest;
softening the wooden piece to which the reinforcing member is attached in a water-vapor atmosphere at a higher temperature and pressure than those in an atmospheric air; and
compressing the softened wooden piece in the water-vapor atmosphere so as to deform the wooden piece into a predetermined three-dimensional shape.

2. The method of forming a wooden piece according to claim 1, wherein the attaching includes, if there are areas on the inner surface of the wooden piece where changes in curvature before and after compression are largest and separation of the grain is largest, attaching the reinforcing member to an area that includes a point where a fiber is most bent due to the compressing.

3. The method of forming a wooden piece according to claim 1, wherein
the reinforcing member includes a plurality of fibers, the fibers being oriented in a direction that intersects with a fiber direction of the wooden piece, and
the plurality of fibers is composed of a material including cellulose that is a wood fiber component.

4. The method of forming a wooden piece according to claim 2, wherein
the reinforcing member includes a plurality of fibers, the fibers being oriented in a direction that intersects with a fiber direction of the wooden piece, and
the plurality of fibers is composed of a material including cellulose that is a wood fiber component.
